(19) United States
(12) Patent Application Publication
(10) Pub. No.: US 2005/0108228 A1
(43) Pub. Date: May 19, 2005

(54) Apparatus and method for performing a polling operation of a single bit in a JTAG data stream

(76) Inventors: Lee A. Larson, Katy, TX (US); Henry R. Hoar, Missouri City, TX (US); Huimin Xu, Missouri City, TX (US)

Correspondence Address: TEXAS INSTRUMENTS INCORPORATED, P O BOX 655474, M/S 3999, DALLAS, TX, 75265, US

(21) Appl. No.: 10/966,662

(22) Filed: Oct. 15, 2004

Related U.S. Application Data
(60) Provisional application No. 60/517,538, filed on Nov. 5, 2003.

(51) Int. Cl. G06F 7/00

(52) U.S. Cl. 707/6

(57) ABSTRACT

In a scan controller in a test and debug system using a JTAG protocol for polling for a signal value, a poll command logic unit compares the value of each logic signal received from a target processor with the value of the expected logic value. The position in the received data stream of each logic value is compared with an expected position. When the expected value and the expected position coincide, a flag is forwarded to the test and debug unit indicating a successful polling operation. A command in the command register of the scan controller enables the apparatus to continue to poll the target processing unit in the absence of the (success) flag.

This application claims priority under 35 USC §119 (e) (1) of Provisional Application No. 60/517,538 (TI-36728P) filed Nov. 5, 2003.

### 1. FIELD OF THE INVENTION

This invention relates generally to the testing of digital signal processing units, and more particularly to techniques for performing polling operations between the target digital signal processor and the test and debug unit for single locations.

### 2. BACKGROUND OF THE INVENTION

As the complexity and number of components on a processing unit chip have increased, the difficulty in testing these chips has increased. One standardized test protocol is the JTAG (Joint Test Action Group) protocol. Referring to FIG. 1, in this test environment, a test and debug unit 5, in response to user inputs applies control and data signals to scan controller 10. The scan control formats the control and data signals and transfers these signals to the target processing unit, the unit under test. The target processing unit 15 performs the activity defined by the control signals and returns the results of the test procedure to the scan control unit 10 with a serial transfer of data. the scan control unit 15 reformats the test result signals from the target processing unit 15 and transfers these signals to the test and debug unit 5 for analysis.

Referring to FIG. 2, a block diagram of the scan controller is shown. The test and debug apparatus enters control signals for the scan controller 10 into the scan controller command register 11. The command register distributes control signals throughout the scan controller 10 to implement the test activity. The test and debug unit 5 also enters test and data signals into input register 12. The test and data signals are entered into the data generator. 14. The data generator 14 reformats the test and data signals and applies the reformatted signals to the target processing unit 8. Data generator 14 exchanges signals with the sequence generator 15. The sequence generator 15, in response to the signals exchanged with the data generator 14 and the control signals received from the command register 11, applies test mode signals to the target processing unit 8. The target processing unit 8, in response to the signals from the data generator 14 and the sequence generator 15, performs the test/debug procedure defined by the test and data signals. After execution of the activity defined by the test and data signals by the target processing unit 8, the results of the test procedure are transferred to the data generator 14. The test result procedure are reformatted and applied to the output register 17. The results of the test procedure are then transferred from the output register to the test and debug unit 5. The test results are then analyzed by the test and debug unit 5 to determine how to proceed with the testing of the target processor.

One common test procedure is “polling”. In polling, a value found at a selected location in the target processor is repeatedly examined until an expected value is found at that location. For each access of the selected location, the same signals much be transferred from the test and debug unit 5 to the scan controller 10 to be forwarded to the target processing unit 8. In addition, the value retrieved from the selected location must be transferred to the test and debug unit 5 to determine whether the expected value was found selected. Thus, the polling procedure requires extensive communication between the components of the testing apparatus. Each individual poll of the selected location requires multiple clock cycles before a determination is made whether the procedure must be repeated. The polling operation is particularly inefficient for procedures that poll for a logic value at one location.

A need has been felt for apparatus and an associated method having the feature of improving the efficiency of the polling operation. It would be a further feature of the apparatus and associated method to provide a comparison between a selected location value and an expected value in the scan controller. It is yet another feature of the present invention, that the polling operation can be implemented in the scan controller without intervention of the test and debug unit. It is still another feature of the present invention to provide apparatus in the scan controller that permits the value retrieved from a selected location to be compared with the expected value in the scan controller. It would be still another feature of the present invention to provide for a plurality of polling operations by the scan controller in response to a command and expected value from the test and debug apparatus. It would be a still further feature of the present invention if it required minimal setup to poll efficiently for a logic value at a particular location.

### SUMMARY OF THE INVENTION

The aforementioned features are accomplished, according to the present invention, by apparatus that permits the polling procedure for an expected logic signal at a single position in the returned data stream, in response to a predetermined command, to be implemented without interaction with the test and debug apparatus. The received data stream has the logic value of each logic signal compared to the expected logic signal. The position of each logic value in the received data stream is compared with the expected value. When the expected logic value and the expected logic value position coincide, a flag is forwarded to the test and debug unit indicating the successful completion of the polling operation. When examination of the received data stream is exhausted without a successful match, the polling operation is repeated. The polling operation can continue for a preselected number of polling operations without the intervention of the test and debug unit.

Other features and advantages of present invention will be more clearly understood upon reading of the following description and the accompanying drawings and the claims.

### BRIEF DESCRIPTION OF THE DRAWINGS

FIG. 1 is a block diagram of the configuration for testing a target processing unit using the JTAG protocol according to the prior art.

FIG. 2 is a block diagram of a scan controller according to the prior art.

FIG. 3 is a block diagram of scan controller according to the present invention.

FIG. 4 is a block diagram of a poll command logic unit according to present invention.

FIG. 5A is a block diagram of a poll command logic unit for determining a signal logic value at a single location according to the present invention, while FIG. 5B illustrated a storage register that can store the expected value parameters for a signal position polling operation.

### DESCRIPTION OF THE PREFERRED EMBODIMENT

### 1. DETAILED DESCRIPTION OF THE FIGURES

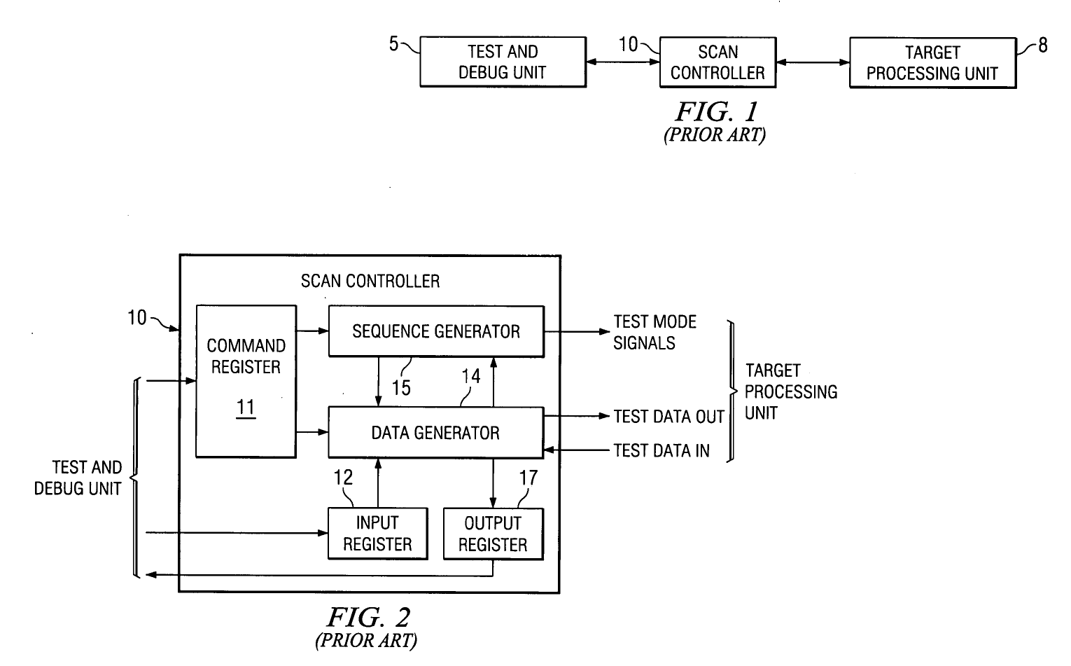

FIG. 1 and FIG. 2 have been described with respect to the prior art.

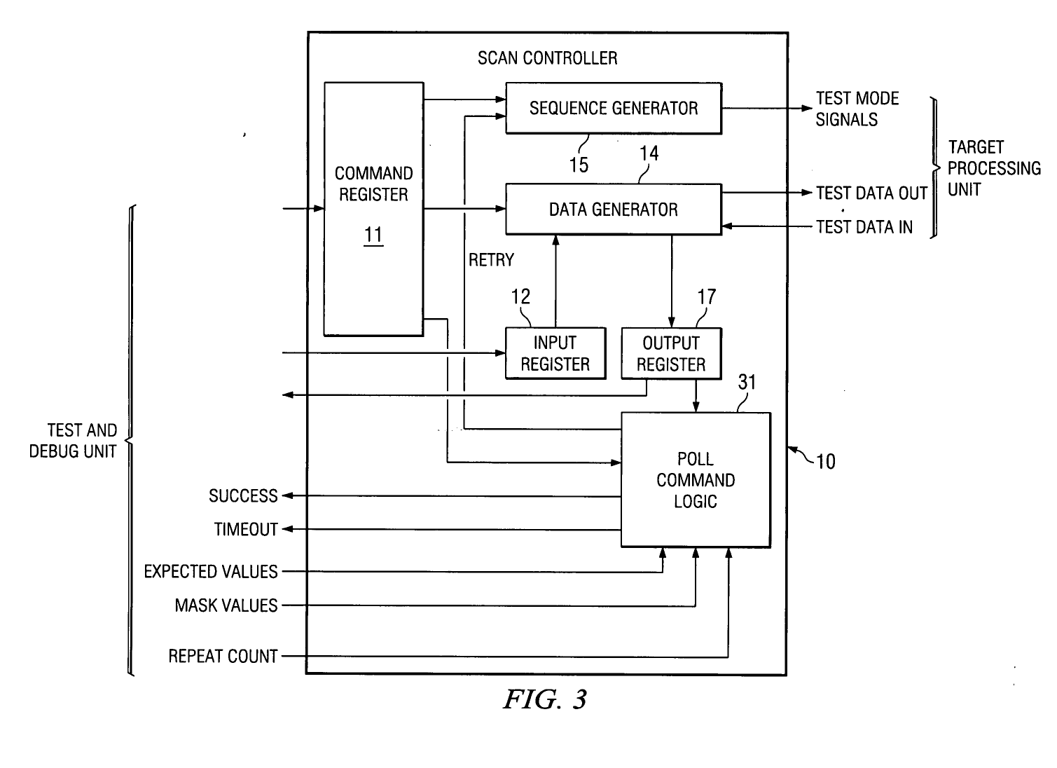

Referring to FIG. 3, a block diagram of the scan controller 30 according to the present invention is shown. The scan controller 30 includes the command register 11, the sequence generator 15, the data generator 14, the input register 12 and the output register 17 as shown in FIG. 2. In addition, the scan controller 30 includes the poll command logic 31. The poll command logic 31 receives command signals from command register 11, and signals from the output register 17. The poll command logic 31 applies a retry signal to the sequence generator 15. The poll command logic applies a success and a timeout signal to the test and debug unit, the success and timeout signals indicating to the test and debug unit whether the polling operation has been successful or not. The poll command logic unit 31 receives an expected value signal, a hit address signal, and a repeat count signal from the test and debug unit.

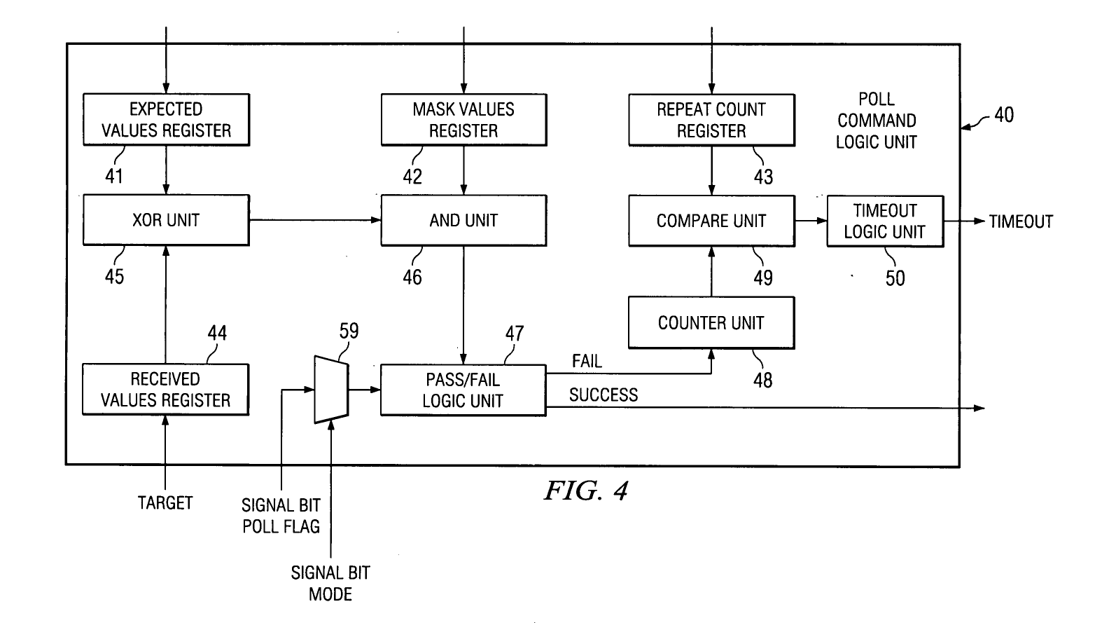

Referring to FIG. 4, a functional block diagram of the poll command logic unit 40, according to the present invention, is shown. The expected value, i.e., the value that is being sought by the polling operation, is entered in the single bit poll logic 41 by the test and debug unit. Similarly, the test and debug program load the bit address in the single bit poll logic 41 and loads the repeat count into the repeat count register 43. In response to the transfer of a data signal group from the scan control unit to the target processing unit, a signal group is returned from the target processing unit and entered in the single bit poll logic 41. The single bit poll logic compares the specified return signal by the bit address with the expected value. The output signal from the single bit poll logic 46 is applied to pass/fail logic unit 47. The pass/fail logic unit 47 generates either a pass signal or a fail signal depending on the signal applied thereto. When a fail signal is generated, this signal is applied to counter unit 48. The counter unit 48 has a count value stored therein incremented by one. The count value stored in the counter unit 49 and the repeat count stored in repeat counter register 43 are applied to compare unit 49. the output signal of compare unit 49 is applied to timeout logic unit 50. When preselected conditions are met, the timeout logic unit 50 issues a time out signal.

In the case of polling for a single bit, the multiplexer 51 selects the single bit poll flag instead of the output of the AND Unit 46.

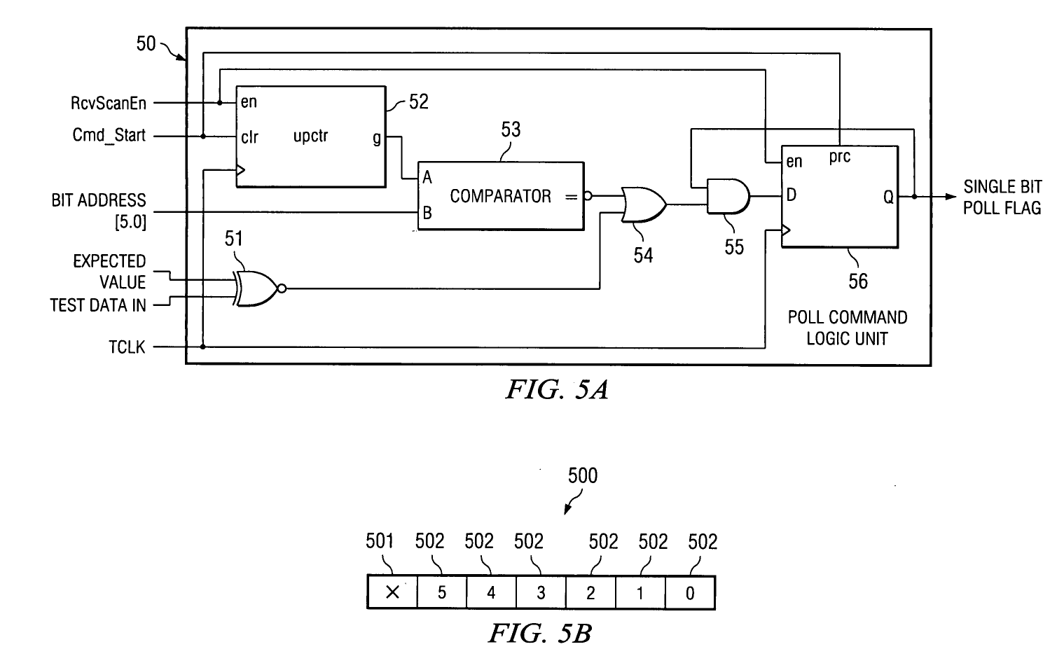

Referring to FIG. 5A, a block diagram of poll command logic 50 capable of polling for a single bit according to the present invention is shown. The Test Data In transferred to the scan controller from the target processor is applied as a series of signals to a first input terminal of logic EXCLUSIVE NOR gate 51. The logic value of the expected signal is applied to the second input terminal of logic EXCLUSIVE NOR gate 51. The output signal of logic EXCUSIVE NOR gate 51 is applied to a first input terminal of logic OR gate 54. A Command_Start signal is applied to a clr terminal of up-counter 52, while a RcvScanEn signal is applied to the en terminal of the up_counter 52. The clk terminal has the TCLK signal applied thereto. The output terminal of the up_counter 52 applies 6 signals to the A input terminal of comparator 53. The B input terminal of comparator 53 receives the 6-bit location of the expected value in the data stream received by the scan controller. The inverted output signal of comparator 53 is applied to a second input terminal of logic OR gate 54. The output signal of logic OR gate 55 is applied to a first input terminal of logic AND gate 55. The output terminal of logic AND gate 55 is applied to the D terminal of D flip-flop 56. The D flip-flop 56 has the TCLK signal applied to the clock terminal, the Cmd_Start signal applied to the preset terminal and the RcvScanEn signal applied to the en terminal. The output signal of the D flip-flop 56 is the single bit poll flag. The output signal of the D flip-flop is applied to the second input terminal of logic AND gate 55.

Referring to FIG. 5B, the expected value storage register 500 for a single position polling operation. Position 501 is the value of the expected logic signal and is applied during the polling procedure to the first input terminal of logic EXCLUSIVE OR gate 51. The 6 bit positions 502 of register 500 identify the position of the expected value in the received data stream and these logic values are applied to the B input terminals of comparator 53.

### 2. OPERATION OF THE PREFERRED EMBODIMENT

The technique for polling to a single logic value can be understood as follows. FIG. 4 provides a a general technique for a JTAG polling operation. However, the apparatus shown in FIG. 4 is inefficient for the polling of a signal location. In the polling of the signal location, all but one of the locations in the expected value register and in the mask register would be zeros.

In FIG. 5A, rather than compare logic signals of a plurality of words from the received data stream that have been stored, the stream of logic value can be compared in real time. The comparison is made using the expected value and bit position stored in register 500. The expected logic value and the logic value of each location in the received data stream are compared. Similarly, the position of the expected logic value in the received data stream is compared with the expected position. When the two comparisons are true simultaneously, a success flag is forwarded to the test and debug unit indicating successful polling operation.

Because this polling operation is implemented under control of commands stored in the command register of the scan controller, the polling operation can be repeated until a successful polling operation is identified. The repeated polling operations can be performed without the intervention of the test and debug unit.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

1. A poll command controller for polling an expected value at a single bit position using JTAG protocol, the controller comprising:
a first comparator, the first comparator determining when a logic value in a received data stream is equal to an expected value, the first comparator generating a first signal when the expected value and the received data stream value are equal;
a second comparator, the second comparator determining when an expected received data stream position is equal to an expected received data stream position, the second comparator generating a second signal when the received data stream position is equal to the expected received data stream position; and
a signal generating unit for generating a third signal when the first signal coincides with the second signal.

2. The controller as recited in claim 1 wherein, in the absence of a third signal for a received data stream, the polling operation is repeated.

3. The controller as recited in claim 2 further comprising a counter incremented after each unsuccessful polling operations, the counter generating a fail signal when a fail signal is not generated after a preselected number of counts.

4. The controller as recited in claim 1 wherein the position of the received data stream and the position of the expected data stream are compared each test clock cycle.

5. The controller as recited in claim 1 further comprising a register, the register storing an expected logic value and an expected position in the received data stream.

6. The method for polling a single location in a target processing unit using a JTAG protocol, the method comprising:
comparing an expected logic signal value with each received data stream logic value;
simultaneously, comparing the position in the received data stream of the received data stream logic value being compared with the expected logic value and the expected received data stream position; and
when the expected logic value and the received logic value are equal and when the expected position and the received data stream position are equal, generating a pass signal.

7. The method as recited in claim 6 wherein when a pass signal is not generated during polling operation, repeating the polling operation.

8. The method as recited in claim 7 wherein the polling operation is repeated without intervention of a test and debug unit.

9. The method as recited in claim 6 generating a second signal when the pass signal is not generated after a preselected number of polling operations.

10. A system for polling a signal location in target processor using a JTAG protocol, the system comprising:
a test and debug unit,
a scan controller responsive to signals from the test and debug unit, the scan controller exchanging data signal groups with the target processor, the scan controller including:
a poll command logic unit, the poll command logic unit having:
a first comparison unit comparing an expected data value and a received data stream logic value; and:
a second comparison unit comparing an expected position with each data stream position; and
a signal generating unit responsive to the first comparison unit and the second comparison unit. the signal generating unit generating a first signal when the first comparison unit and the second comparison have positive comparisons simultaneously.

11. The system as recited in claim 10 wherein the scan controller includes a command register, the scan controller responsive to a command in the command register for repeating a polling operation when a first signal is not generated during received data stream comparisons.

12. The system as recited in claim 11 wherein the scan controller further includes an expected value register storing an expected logic signal value and an expected position in the received data stream.

13. The system as recited in claim 11 wherein the scan controller further includes a counter unit, the counter unit generating a second signal when a polling operation is unsuccessful for predetermined number of received data stream.

14. The system as recited in claim 11 wherein the position of the received data stream and the position of the expected data stream are compared each test clock cycle.
